(19) United States
(12) Patent Application Publication
(10) Pub. No.: US 2004/0191743 A1
(43) Pub. Date: Sep. 30, 2004

(54) System and method for software development self-assessment

(75) Inventors: Beng K. Chiu, San Jose, CA (US); Wanda Sarti, Lago Vista, TX (US); William Michael Woodworth, Cary, NC (US)

Correspondence Address: Samuel A. Kassatly, 6819 Trinidad Drive, San Jose, CA, 95120, US

(73) Assignee: International Business Machines Corporation, Armonk, NY

(21) Appl. No.: 10/400,256

(22) Filed: Mar. 26, 2003

(51) Int. Cl. G09B 7/00

(52) U.S. Cl. 434/322

(57) ABSTRACT

A software development self-assessment is a guide to good software development practices that have been adopted by experienced software developers that have produced quality software. The present system encourages self-assessors to evaluate themselves over a period of time, gauge progress, and calibrates those assessments against metrics that measure the quality of their software products. The use of good software-development practices results in lower cost of software development, improved quality of the software product, increased customer satisfaction, and lower service cost for the software product. The present system stimulates the adoption of practices that may not have been employed within a development group. In addition, the present system can be used to further the implementation of such practices to the entire development organization. The present system also addresses dependency management and risk assessment, and enhances practice-sharing, as questions related to good practices are asked of various project members or team leads which lead to a possible comparison of practice usage calibrated to measured quality of software products.

### FIELD OF THE INVENTION

The present invention generally relates to self-assessment examinations. More particularly, this invention relates to a self-assessment examination for promoting and developing good practices in software development. Specifically, the questions in the self-assessment examination are developed by experienced software developers skilled in the art of good software development practices, to create an expert system for use in guiding software development practices.

### BACKGROUND OF THE INVENTION

The software development industry is populated by organizations with varying software-development process knowledge and experience levels. These software development labs typically have defined group software development practices. However, these development practices are often not provided in a self-assessment form and not shared among the group to maintain good software development practices and improve software development skills.

Software development groups often contain diversity within these units. This diversity exists in terms of knowledge in process and platforms for which the group writes software. In addition, there is diversity in philosophy regarding how the group measures the quality of products or software programs they produce. For each software product developed, there exists a balance between speed to market, cost, function, and quality. Maintaining this balance between quality of product and cost to develop the product requires constant diligence in pursuing good software development practices and in evaluation by development group members. Often, this process is overlooked during the effort to develop and market a software product, resulting in missed deadlines and cost overruns.

What is therefore needed is an easy-to-use self-assessment procedure that will encourage and promote the use of good software development practices within the development group and company. The need for such a system has heretofore remained unsatisfied.

### SUMMARY OF THE INVENTION

The present invention satisfies this need, and presents a system, a computer program product, and an associated method (collectively referred to herein as “the system” or “the present system”) for software development self-assessment. The present system is a guide to good software development practices that have been developed by experienced software developers having produced quality software. The present system represents a collection of software development practices combined into the present system. This extensive set of good software practices allows self-assessment of software development organizations in comparison to the best available practices.

The present system encourages self-assessors to evaluate themselves over a period of time, gauge progress, and calibrate those assessments against metrics that measure the quality of their software products. Consistent use of the present system can enhance the use of good software development practices within the software development organization. The use of good software-development practices results in lower cost of software development, improved quality of the software product, increased customer satisfaction, and lower service cost for the software product.

The present system encourages a self-evaluation of the processes in each software development organization to continually improve the quality of their software end products. The purpose of the present system is to stimulate the adoption of practices that may not have been employed within a development group.

In addition, the present system can be used to further the implementation of such practices to the entire development organization. The present system is particularly useful for companies or software development groups that develop complex software, especially those with distinct organizational boundaries that separate developers from tester, technical information writers, library builders, and service personnel.

The present system also addresses dependency management and risk assessment. This is especially useful in the mitigation of risk factors such as the integration among software products that must work together to deliver value to the customer.

The advantage of the present system lies in the completeness of the assessment questions pertinent to the software technical planning, design, and coding teams. The present system expands the horizon of the software developer to specific interactions with customers, testers, performance calibrators, information developers, library build teams, and service personnel.

Many types of organizations, from start-ups to mature development organizations, can benefit from the use of the present system. Start-up software development companies will have the benefit of a mature system mentor focusing attention on development essentials learned through experience.

Mature development organizations will have a tool that can be used to monitor and continually improve the efficacy of existing development processes and practices.

In addition, the present system can be used in training new software engineers, and introducing them to proven software development techniques.

The present system can also be packaged into an assessment tool for a software development consultant working with his/her client, presumably a software development company. The consultant could present the results to a client interested in improving his/her software development processes. Working together, both consultant and client could assess the organization and institute qualitative measures and quantitative metrics over time to drive improvements.

A feature of the present system lies in the exposition of good practices to the self-assessors. The questions probe, not only if the self-assessors use a particular practice, but also the degree of usage within the organization, as well as the reasoning behind why a practice is or is not used. The assessment also inquires how a practice is used and whether or not benefits are being realized for usage of the practice.

The use of the present system can bring discipline to the art and practice of software development without diminishing creativity because the present system asks pertinent software development questions without subjecting the self-assessors to a scoring mechanism. The present system enhances practice-sharing, as questions related to good practices are asked of various project members or team leads which lead to a possible comparison of practice usage calibrated to measured quality of software products.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a software development self-assessment system of the present invention can be used;

FIG. 2 is a process flow chart illustrating a method of operation of the software development self-assessment system of FIG. 1;

FIG. 3 comprises FIGS. 3A, 3B, 3C, 3D, and 3E, and represents a screen display of the interface for section A of the software development self-assessment system of FIG. 1;

FIG. 4 comprises FIGS. 4A, 4B, 4C, 4D, 4E, 4F, 4G, 4H, and 4I, and represents a screen display of the interface for the development process management portion of section B of the software development self-assessment system of FIG. 1;

FIG. 5 comprises FIGS. 5A, 5B, 5C, and 5D, and represents a screen display of the interface for the code design and development portion of section B of the software development self-assessment system of FIG. 1;

FIG. 6 comprises FIGS. 6A and 6B, and represents a screen display of the interface for the cooperation during formal test portion of section B of the software development self-assessment system of FIG. 1;

FIG. 7 comprises FIGS. 7A, 7B, and 7C, and represents a screen display of the interface for the technology management portion of section B of the software development self-assessment system of FIG. 1;

FIG. 8 is a screen display representing the interface for the strengths and weaknesses portion of section B of the software development self-assessment system of FIG. 1;

FIG. 9 comprises FIGS. 9A, 9B, 9C, 9D, and 9E, and represents a screen display of the interface for section C of the software development self-assessment system of FIG. 1;

FIG. 10 comprises FIGS. 10A, 10B, 10C, 10D, 10E, and 10F, and represents a screen display of the interface for section D of the software development self-assessment system of FIG. 1;

FIG. 11 is a screen display representing the interface for section E of the software development self-assessment system of FIG. 1;

FIG. 12 is a screen display representing the interface for the strengths and weaknesses portion of section F of the software development self-assessment system of FIG. 1; and

FIG. 13 comprises of FIGS. 13A, 13B, 13C, and 13D and represents an exemplary response to the questions of section A of the software development self-assessment system of FIG. 1.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Button: A clickable box or icon on the computer screen that is a shortcut for a command.

Internet: A collection of interconnected public and private computer networks that are linked together with routers by a set of standards protocols to form a global, distributed network.

Radio button: A group of buttons on the computer screen of which only one can be selected at a time by clicking on it. Radio buttons are often used with interactive forms on World Wide Web pages.

World Wide Web (WWW, also Web): An Internet client-server hypertext distributed information retrieval system.

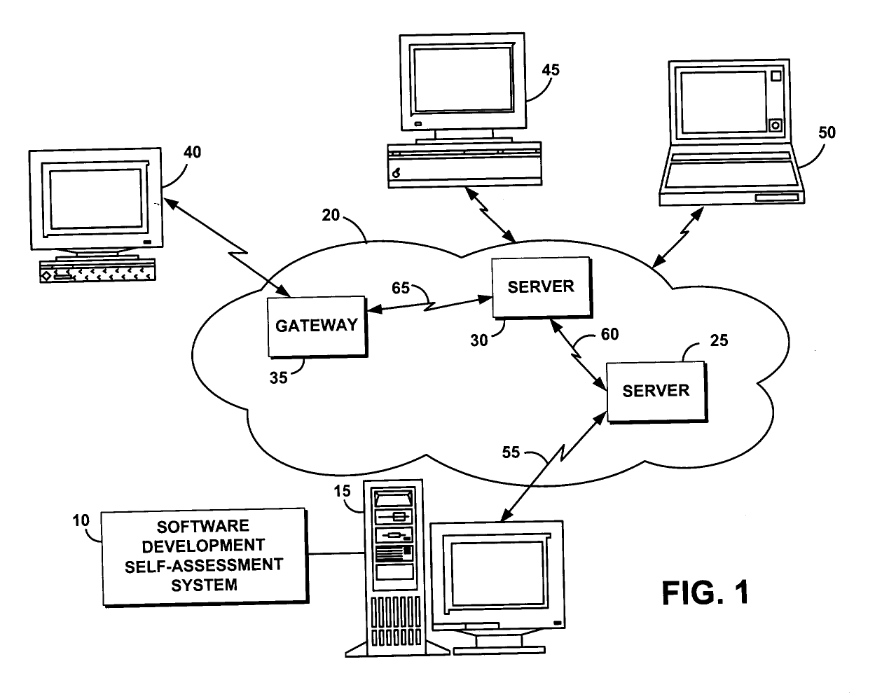

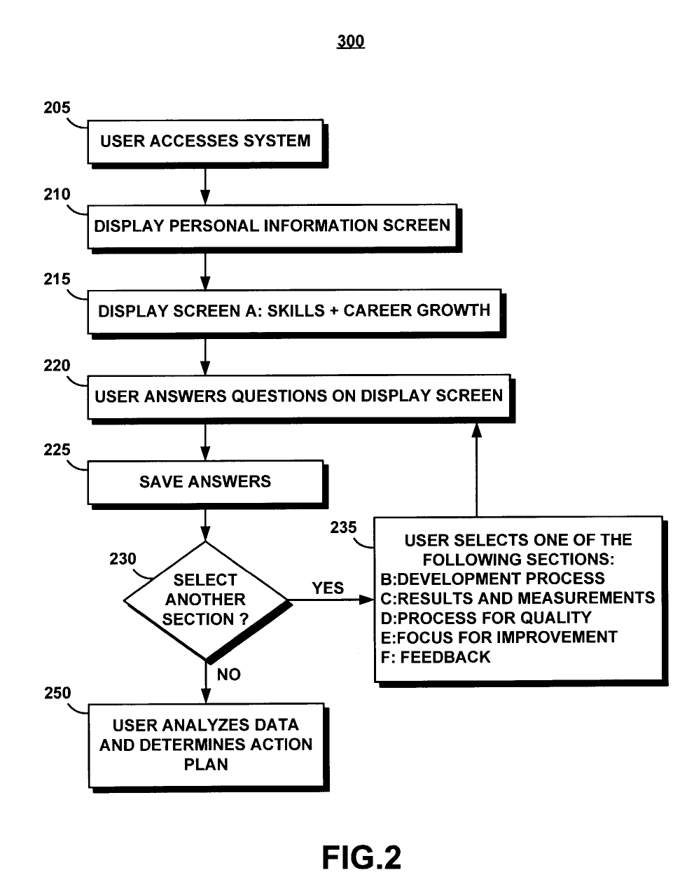

FIGS. 1 and 2 portray an exemplary overall environment in which a system 10 and associated method 200 for providing a software development self-assessment according to the present invention may be used. System 10 includes a software programming code or computer program product that is typically embedded within, or installed on a host server 15. Alternatively, system 10 can be saved on a suitable storage medium such as a diskette, a CD, a hard drive, or like devices. While the system 10 will be described in connection with the WWW, the system 10 can be used with a wide area network, a local area network, or operate independently on a computer.

The cloud-like communication network 20 comprises communication lines and switches connecting servers such as servers 25, 30, to gateways such as gateway 35. The servers 25, 30 and the gateway 35 provide the communication access to the WWW or Internet. Users, such as software developers accessing system 10, are represented by a variety of computers such as computers 40, 45, 50, and can access the host server 15 through the network 20.

Each of computers 40, 45, 50 includes software that will allow the user to browse the Internet and interface securely with the host server 15. The host server 15 is connected to the network 20 via a communications link 55 such as a telephone, cable, or satellite link. The servers 25, 30 can be connected via high-speed Internet network lines 60, 65 to other computers and gateways.

FIG. 2 is a process flowchart that illustrates the method 200 of system 10. The user accesses system 10 at block 205. At block 210, system 10 displays a personal information screen for the user. The user may update or enter new information as required on the personal information screen.

After the user enters the required information, system 10 displays section A, skills and career growth, at block 215. The user answers questions on the display screen at block 220. System 10 saves or stores the user's answers at block 225.

At decision block 230, the user has the option to select another section for assessment. If so, the user can select among the following sections at block 235:

section B, development process;

section C, results and measurements;

section D, process for quality;

section E, focus for improvement; or

section F, feedback.

System 10 then returns to block 220. The user answers the questions on the screen, and system 10 saves the answers at block 225.

If at decision block 230 the user does not select another section, system 10 proceeds to decision block 250 to analyze the data accumulated from system 10 and to determine an action plan to improve software development performance of the group or company.

Method 200 can be repeated periodically to compare results with previous assessments. If improvement in software development practices is noted as needed, management can then formulate a different plan for improvement. In one embodiment, a set of buttons are added at the end of each section (block 235), to allow the user to return to the main menu.

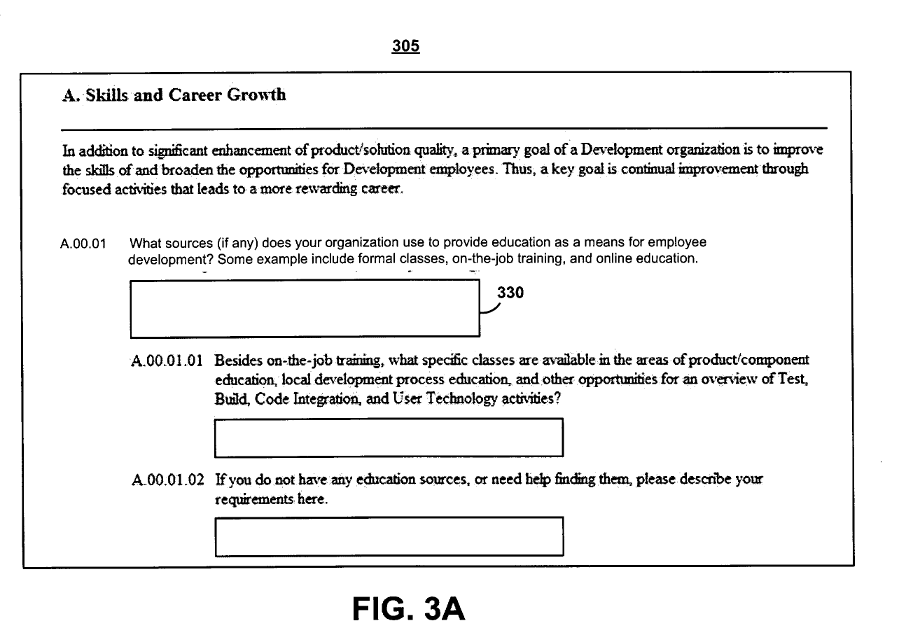

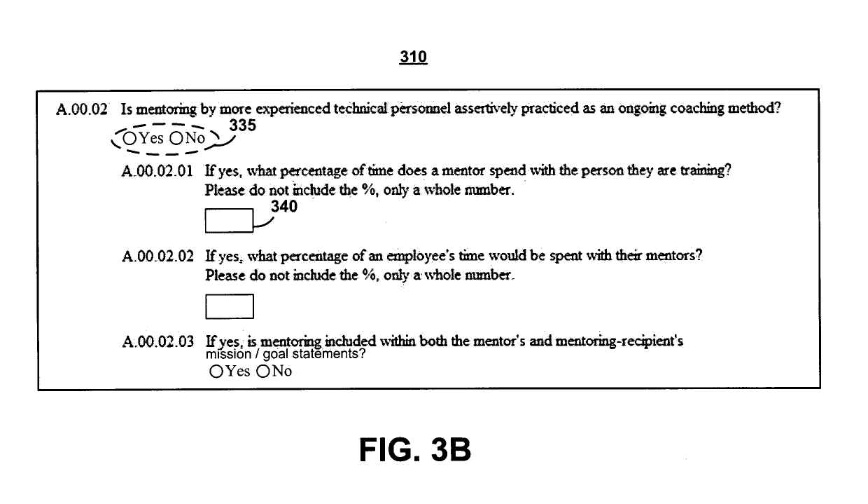

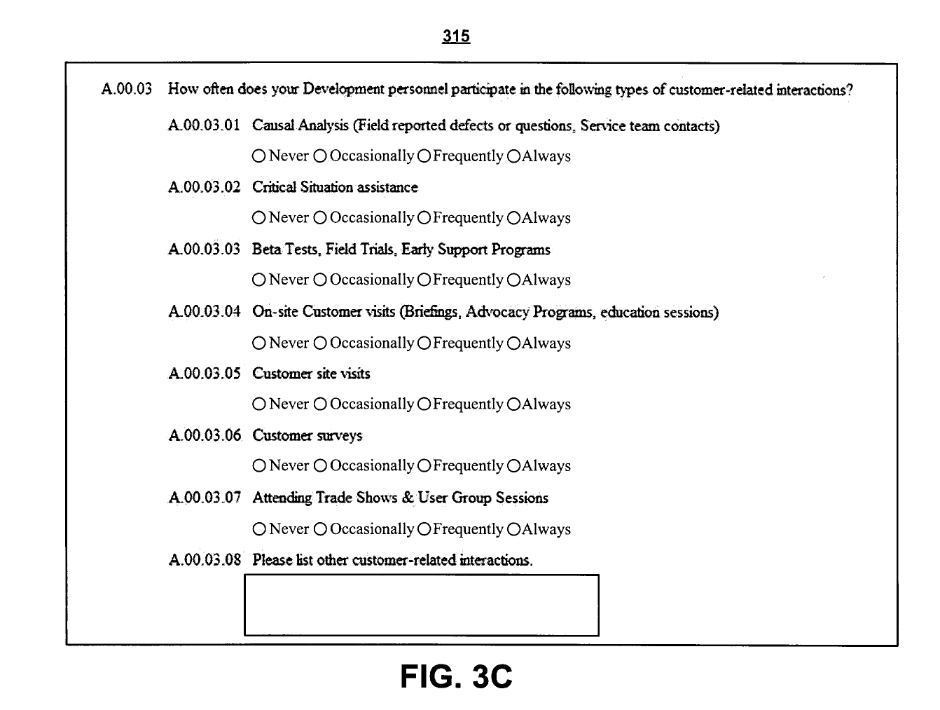

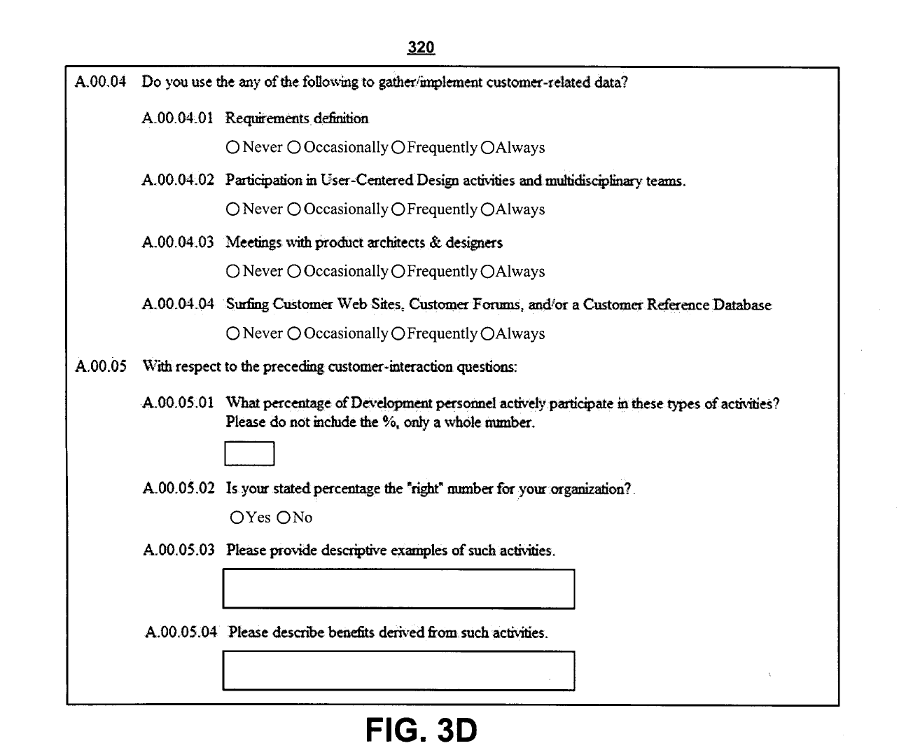

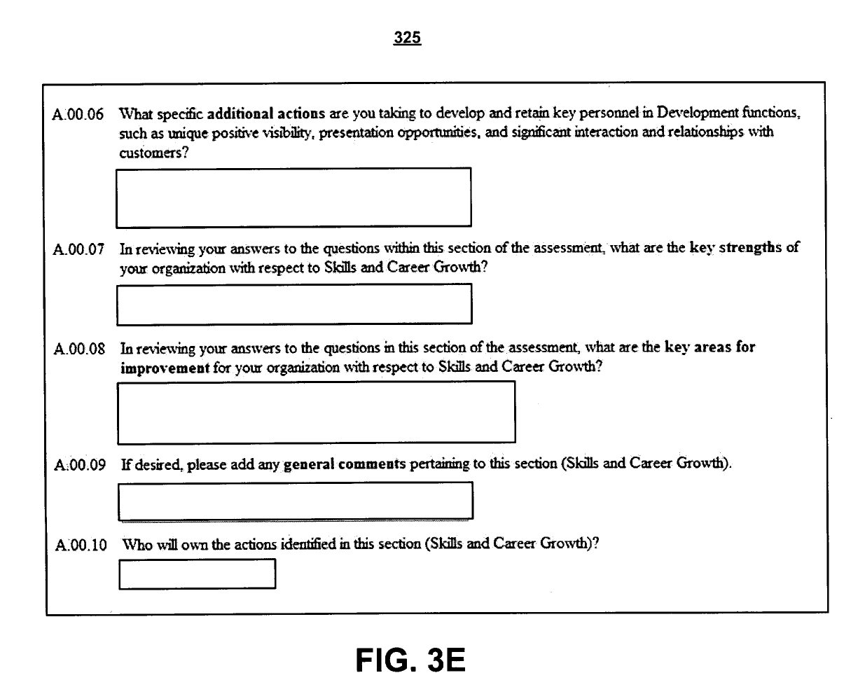

Exemplary questions presented to the user are displayed in FIGS. 3 through 11. The user may choose any one or all of the sections for assessment. The questions for section A, skills and career growth, are shown in FIG. 3 (FIGS. 3A, 3B, 3C, 3D, and 3E). Although shown in separate screens, the user accesses the questions by scrolling through them.

The questions are divided into screens by topic for ease of discussion. These questions probe the opportunities for continuing education offered to the software designer and encourage participation in those opportunities in screen 305.

In screen 310, system 10 assesses mentoring opportunities for the user. The questions in screen 315 and screen 320 address customer-related interactions. Skills and assessment review questions are presented in screen 325. The user answers questions either by typing responses into response boxes such as box 330 (FIG. 3A), selecting a “yes/no” response by clicking on the appropriate “radio button” such as button 335 (FIG. 3B), or by typing a number into a response box such as box 340 (FIG. 3B).

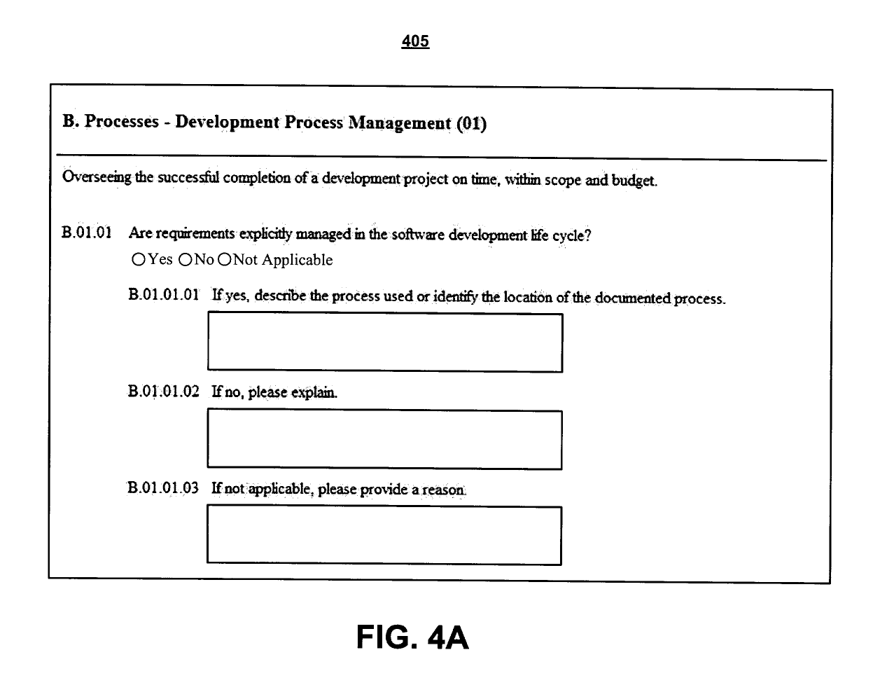

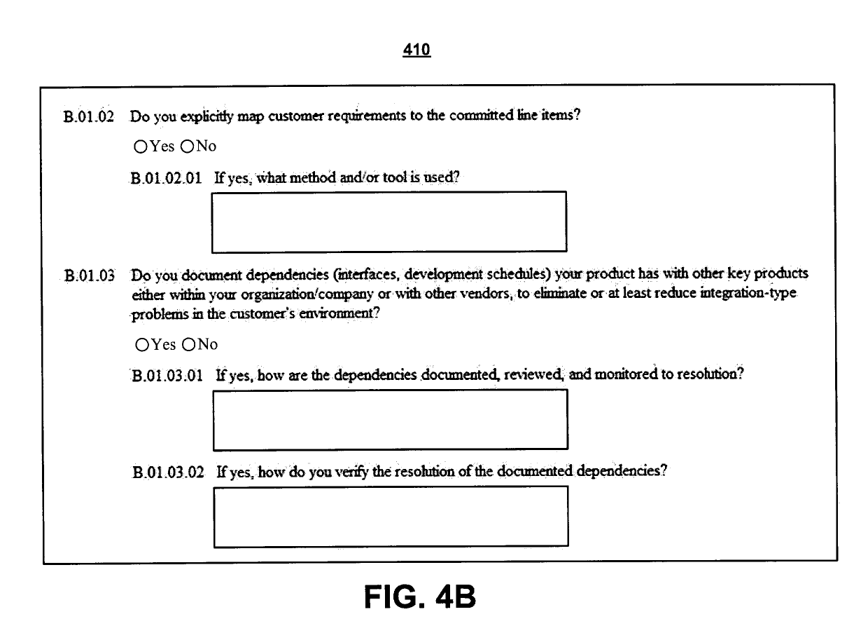

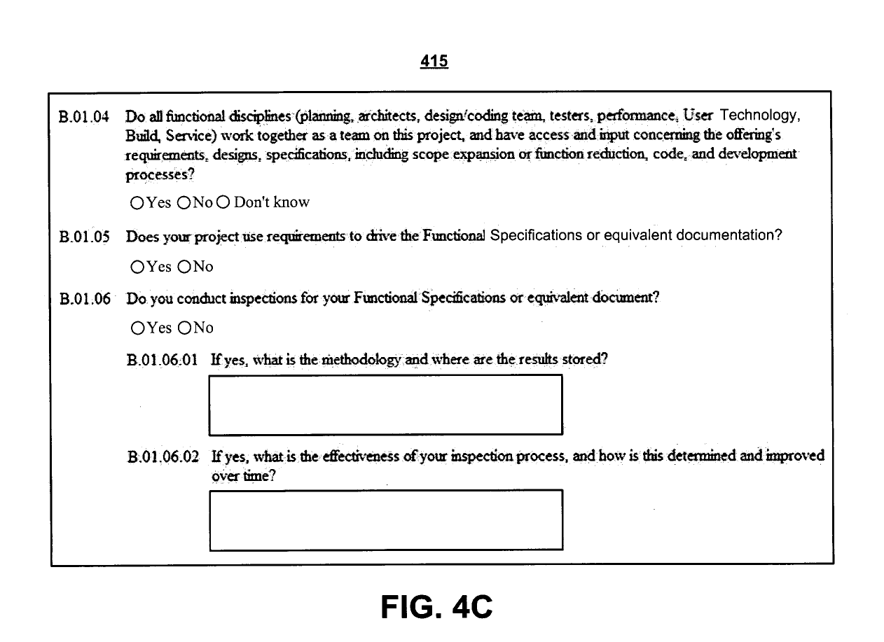

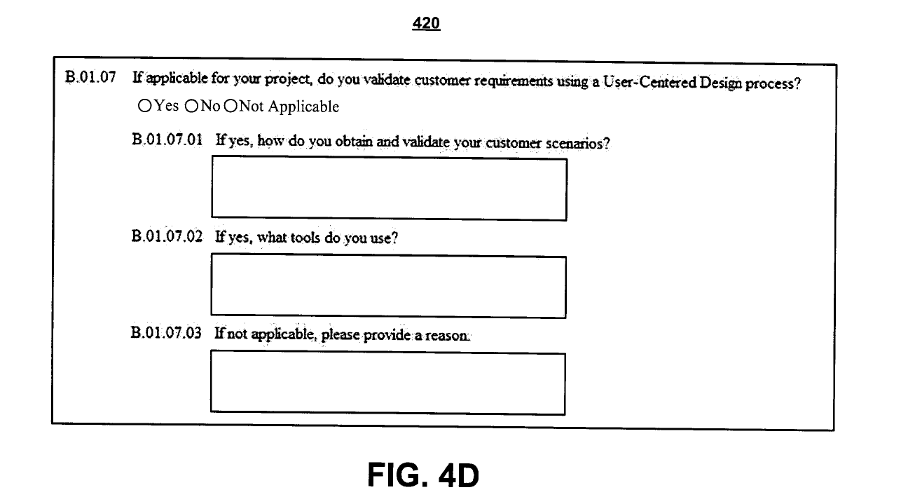

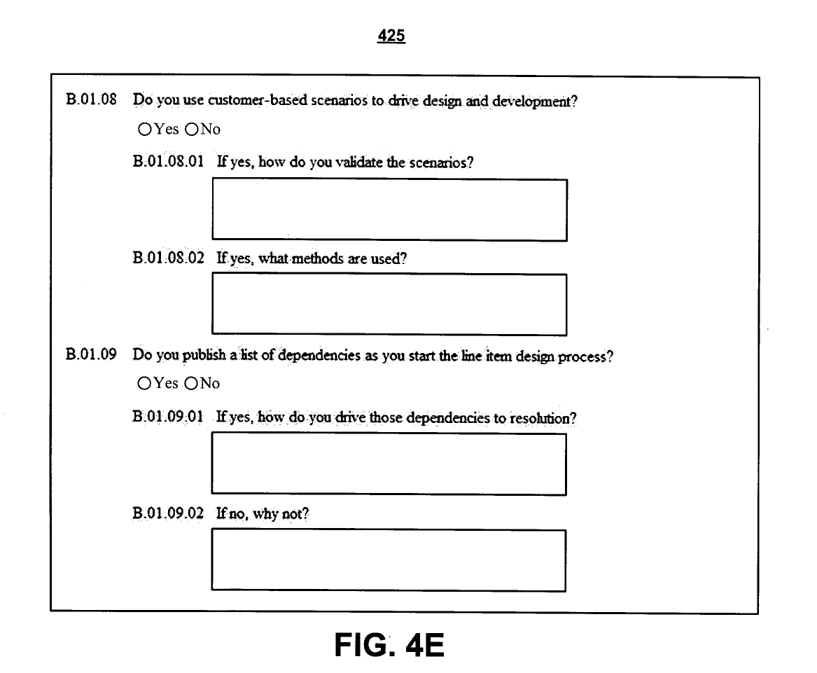

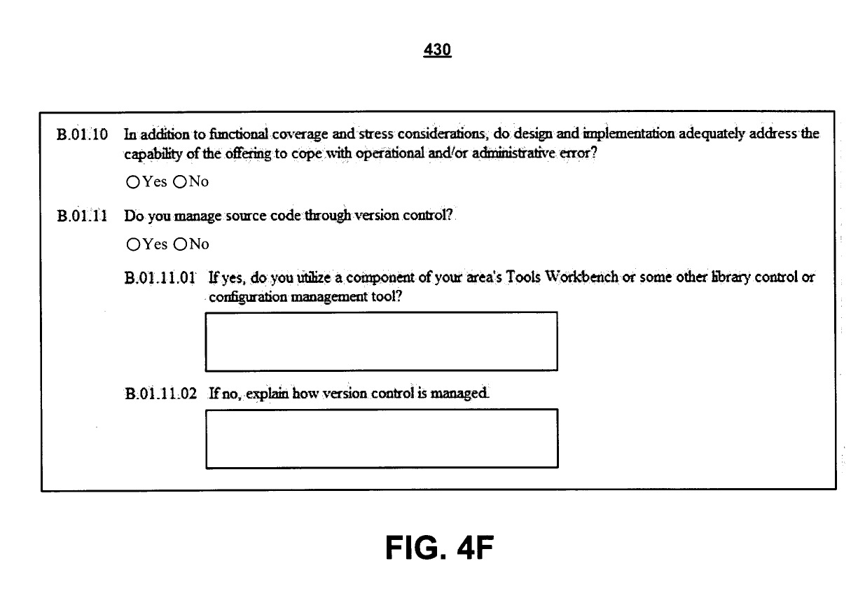

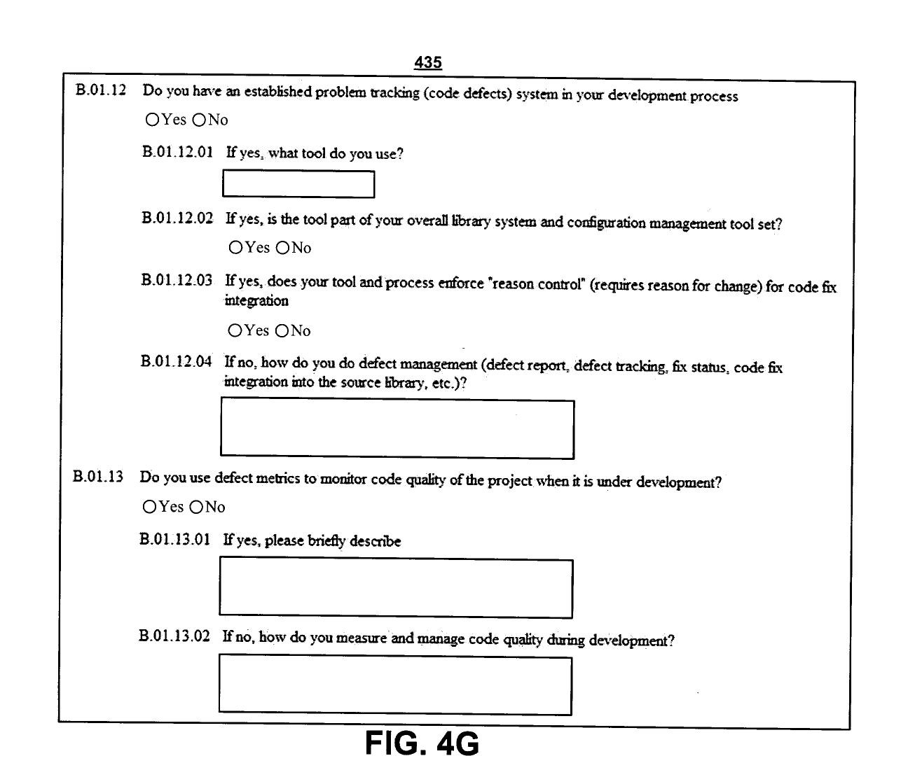

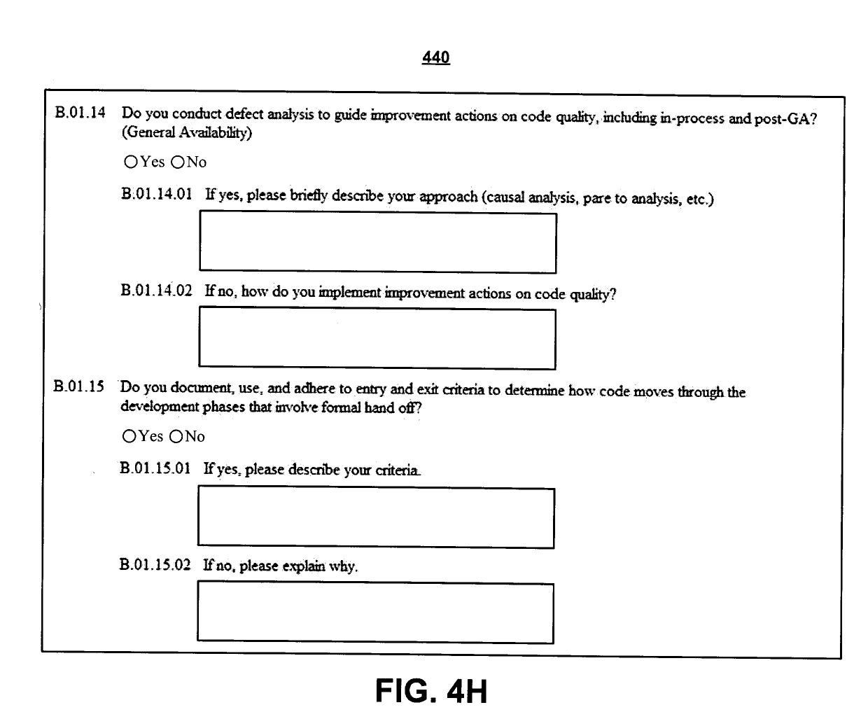

The processes assessment section, section B, comprises five subsections, each of which is presented separately in FIGS. 4 through 8. The assessment questions for the development process management subsection of section B are shown in FIG. 4 (FIGS. 4A, 4B, 4C, 4D, 4E, 4F, 4G, 4H, and 4I). Screens 405 (FIG. 4A) and 410 (FIG. 4B) question the software development requirements. The bottom half of screen 410 introduces questions on integration-type dependencies.

Screen 415 (FIG. 4C) addresses functional dependencies and specifications. Customer-based design procedures are the focus of screens 420 (FIG. 4D) and 425 (FIG. 4E). Various aspects of quality control, version tracking, and documentation are addressed in screens 430, 435, 440, and 445 (FIGS. 4F, 4G, 4H, and 4I, respectively).

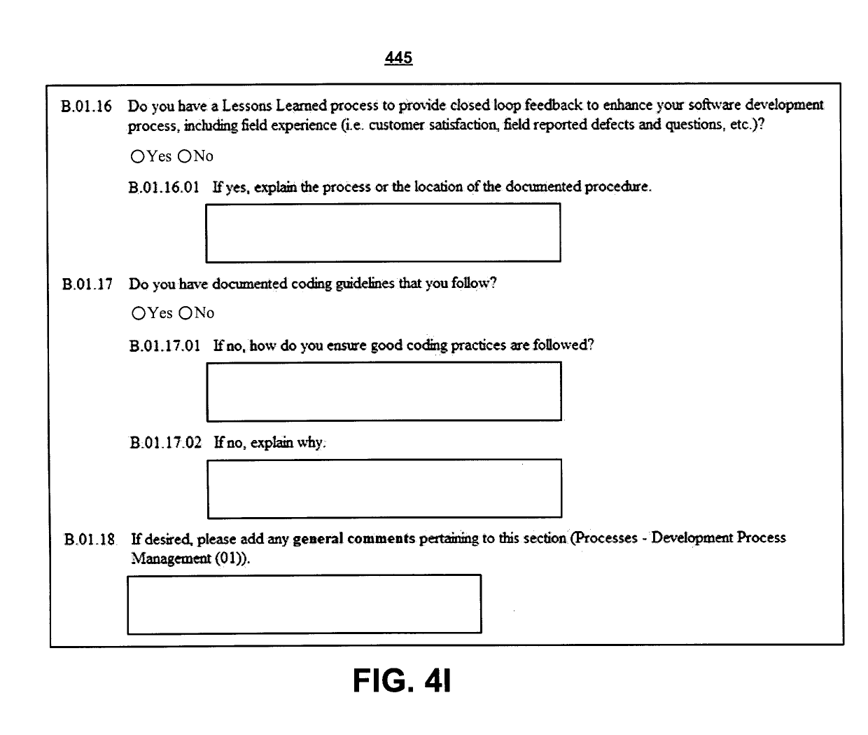

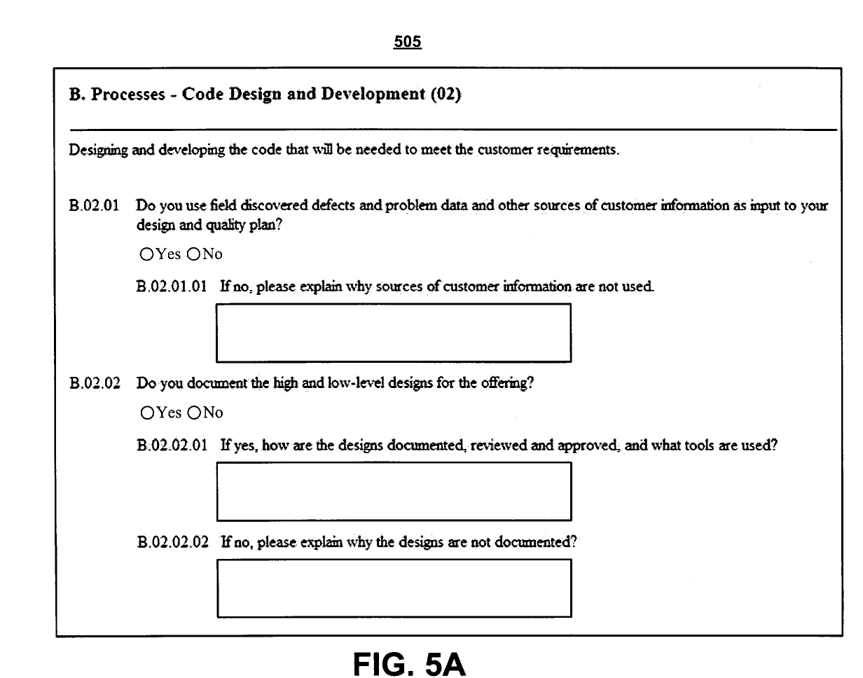

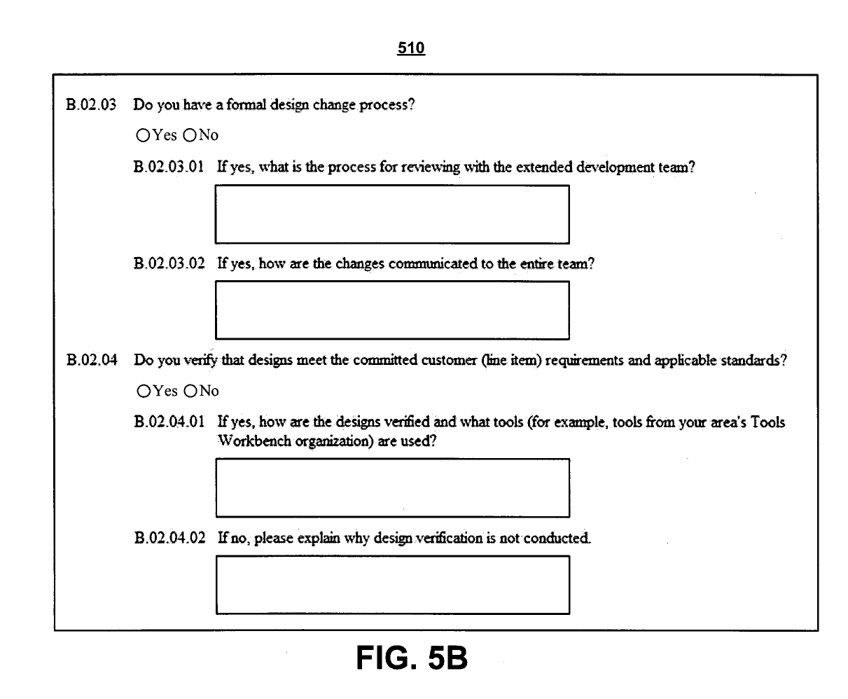

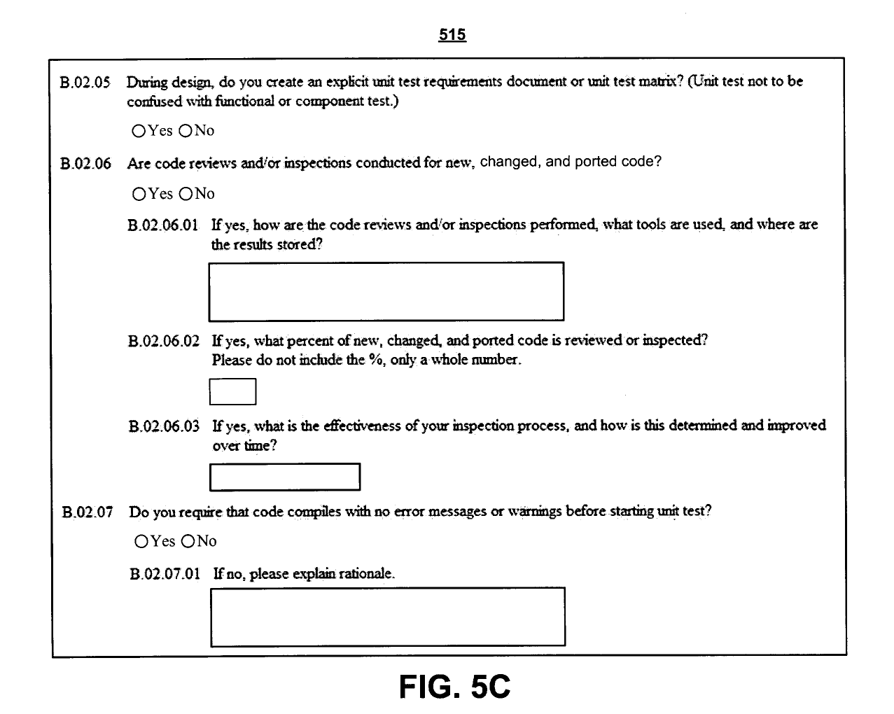

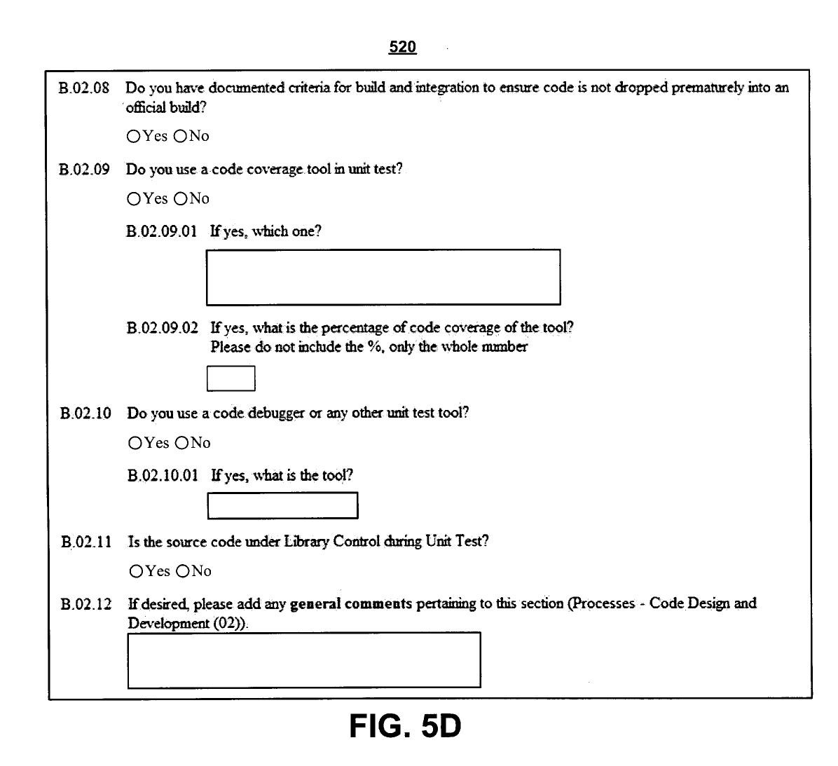

The code design and development subsection of section B is shown in FIG. 5 (FIGS. 5A, 5B, 5C, and 5D). Screens 505, 510, 515, and 520 illustrated in those figures, present exemplary questions tailored to assess the process of designing and developing code needed to meet the customer's requirements.

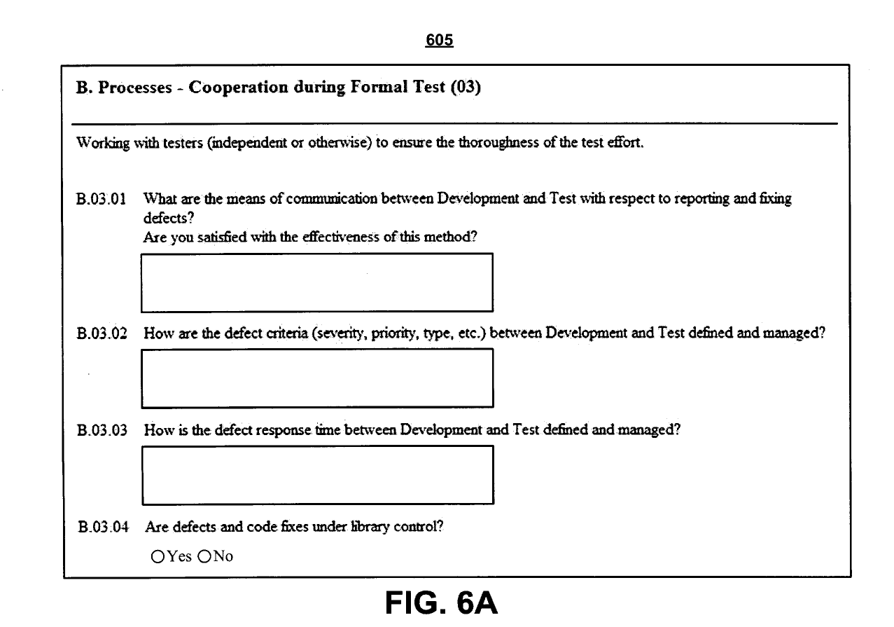

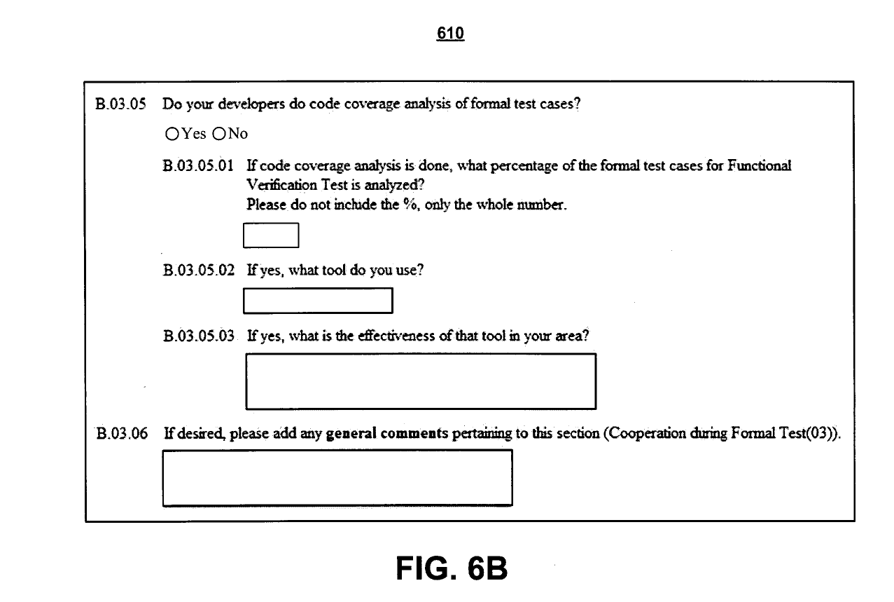

The cooperation during formal test subsection of section B is shown in FIG. 6 (FIGS. 6A and 6B). Screens 605 and 610 address the assessment of working with software testers to ensure the thoroughness of the test effort.

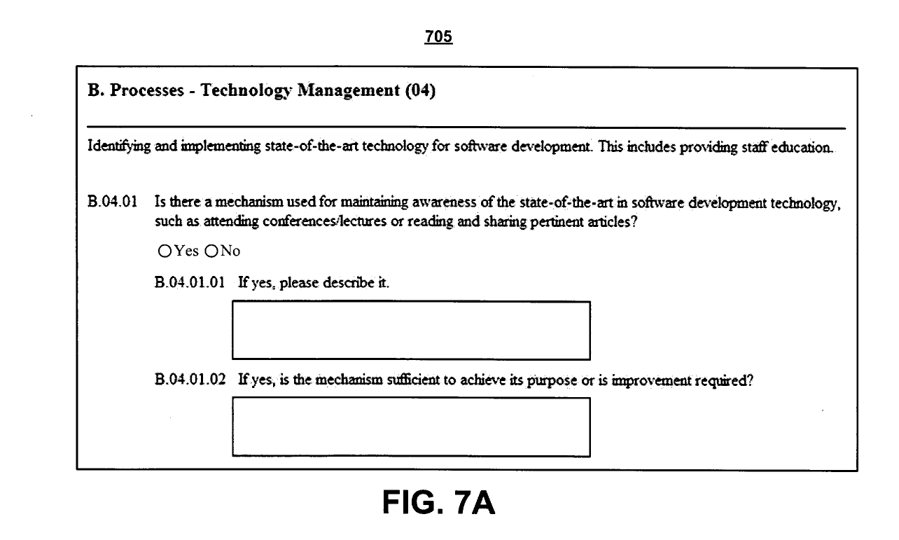

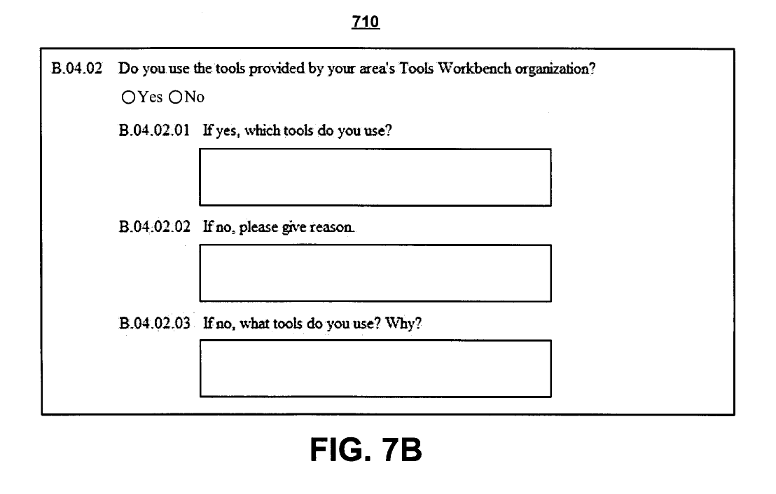

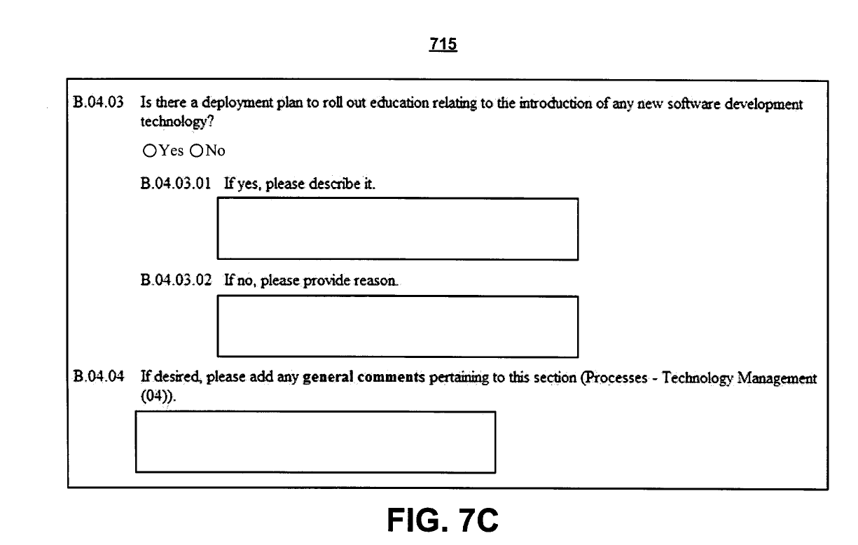

The technology management subsection of section B is shown in FIG. 7 (FIGS. 7A, 7B, and 7C). Screens 705, 710 and 715 in those figures, address the assessment of identifying and implementing state-of-the-art technology for software development including providing staff education.

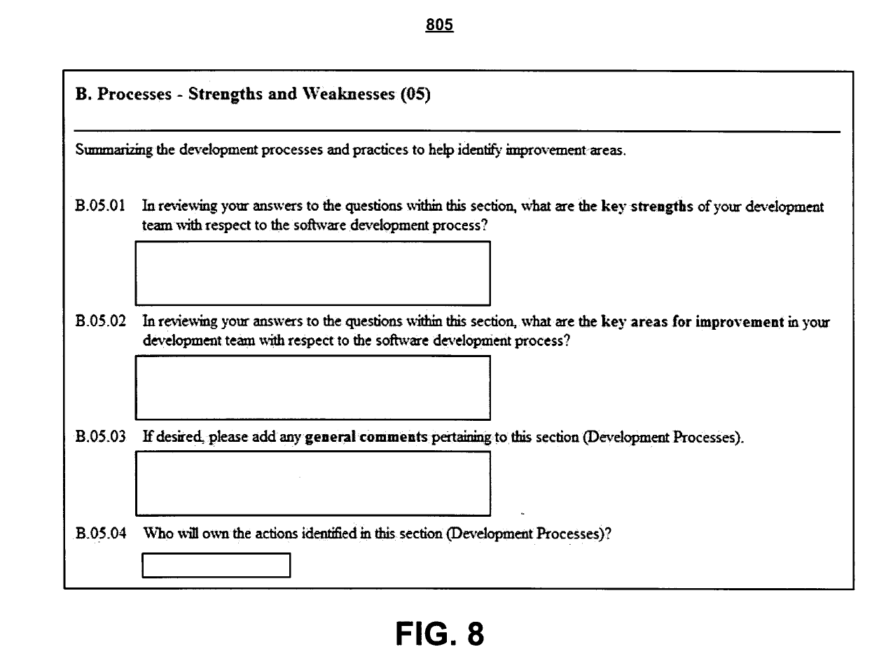

The development process and practices to help identify improvement areas, is illustrated in FIG. 8, strengths and weaknesses. Screen 805 of FIG. 8 presents exemplary questions that summarize this section.

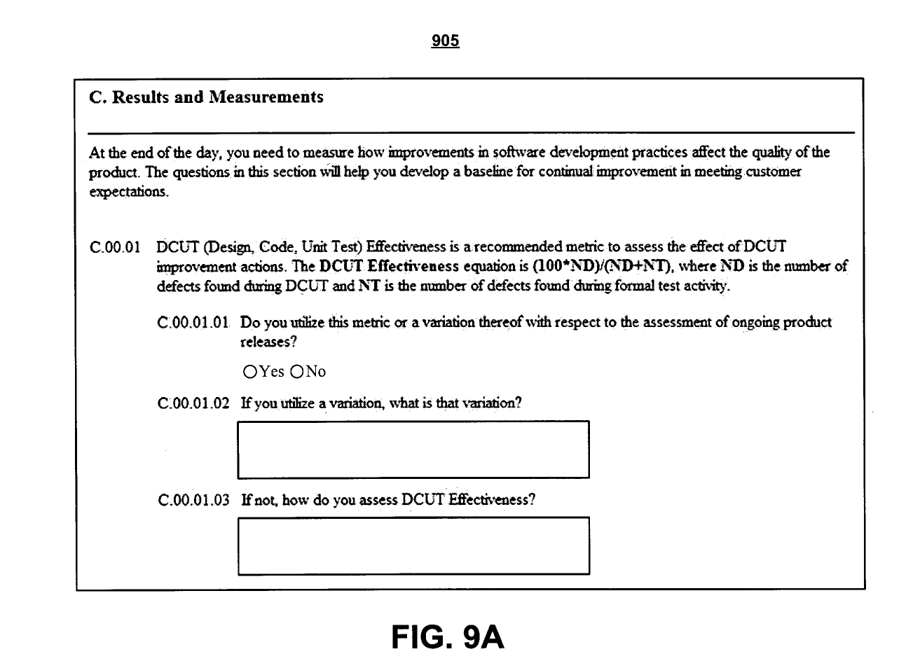

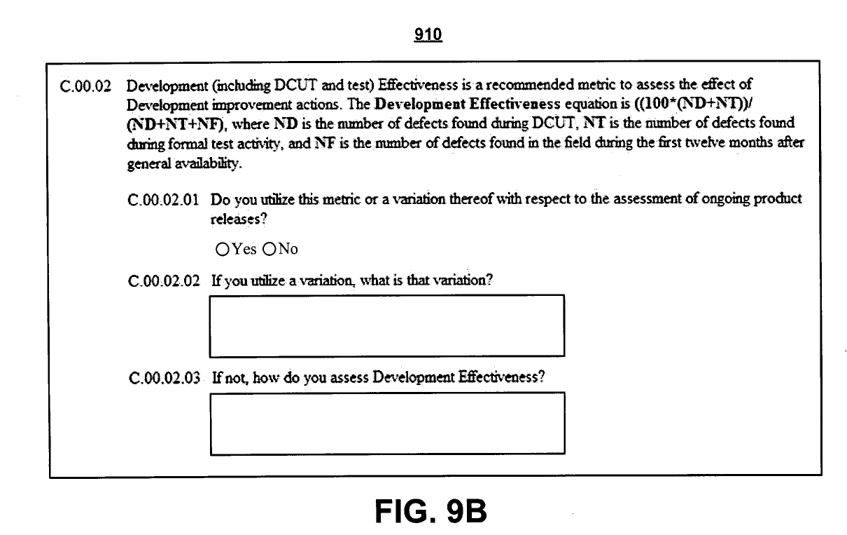

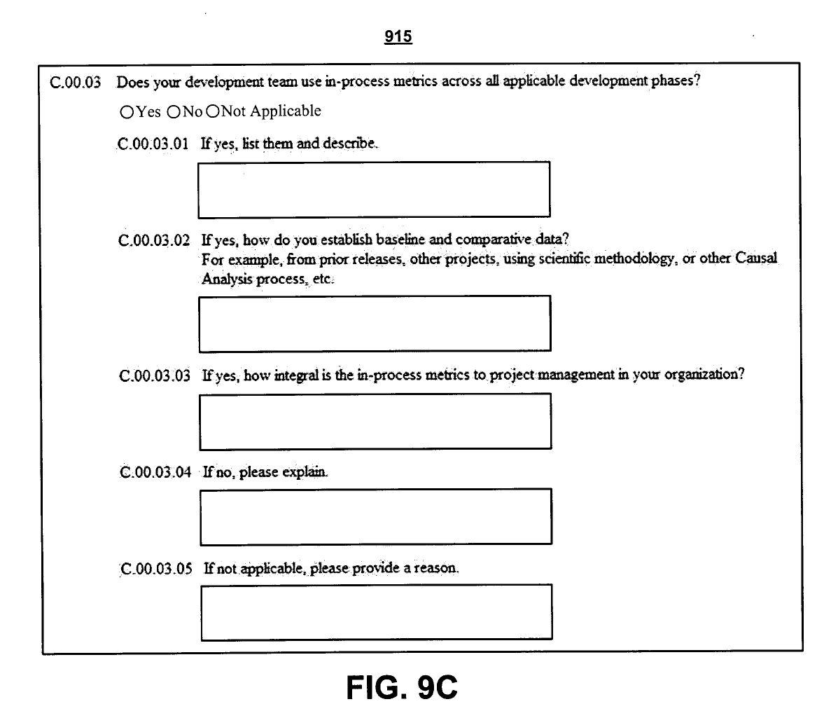

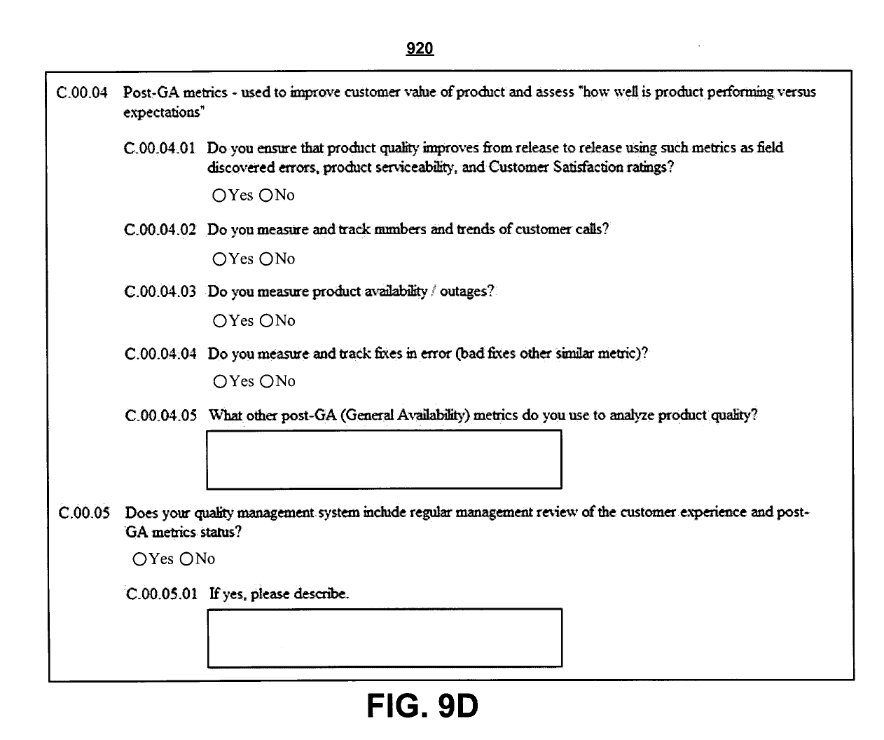

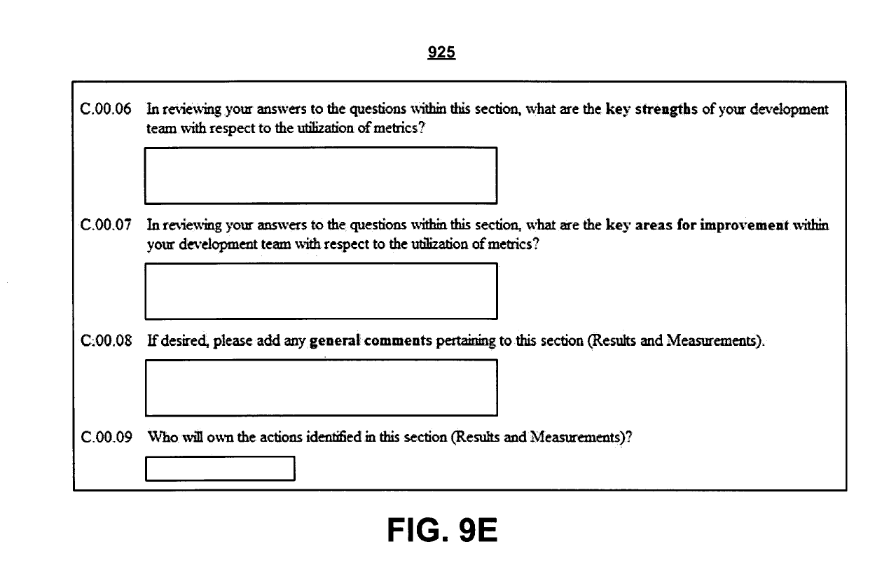

Section C, results and measurements, is shown in FIG. 9 (FIGS. 9A, 9B, 9C, 9D, and 9E). The assessment questions provided in screens 905, 910, 915, 920, and 925 address the measurement of the effect improvements in software development practices have on quality of the software product. The exemplary questions in section C help the user develop a baseline for continual improvement in meeting customer expectations.

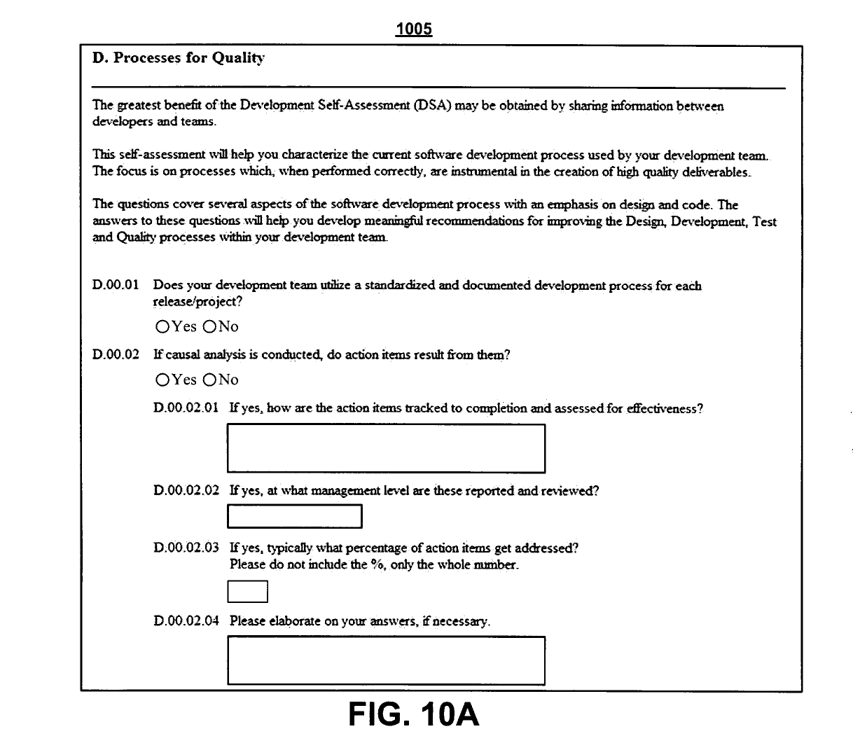

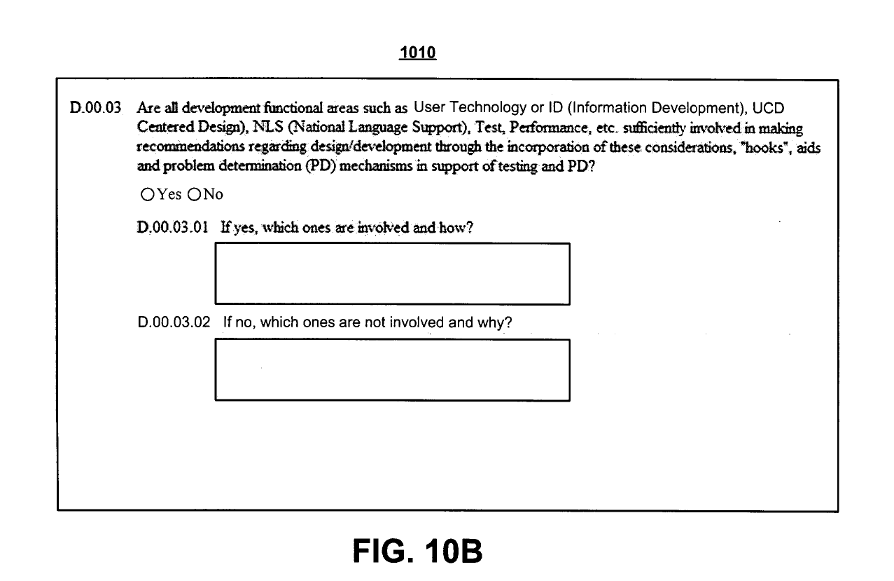

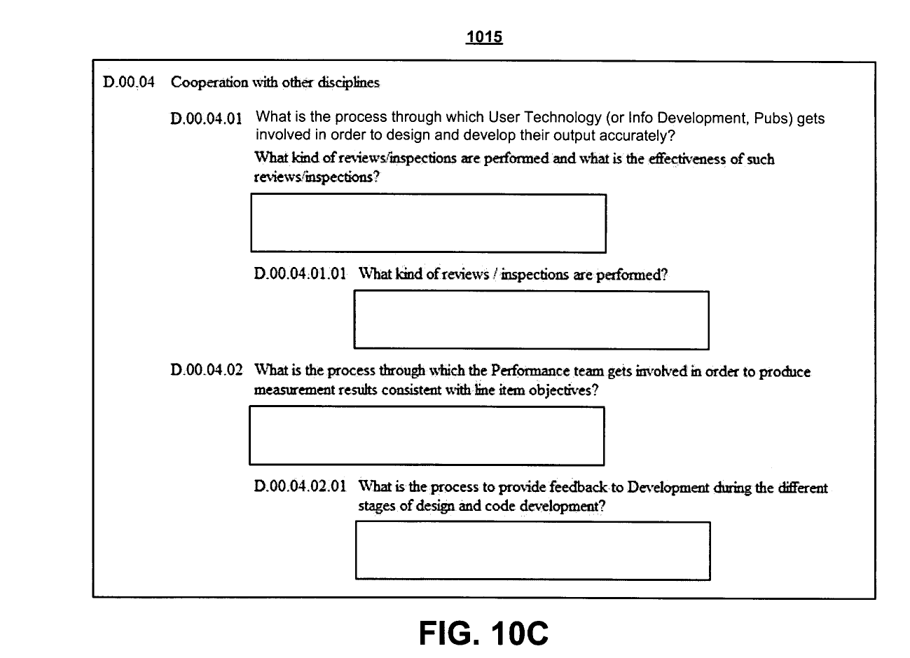

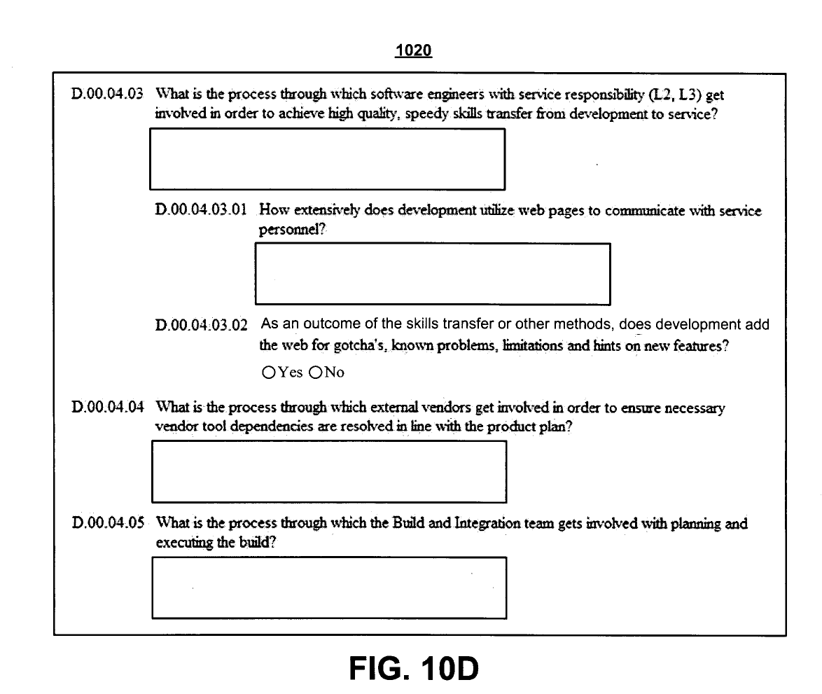

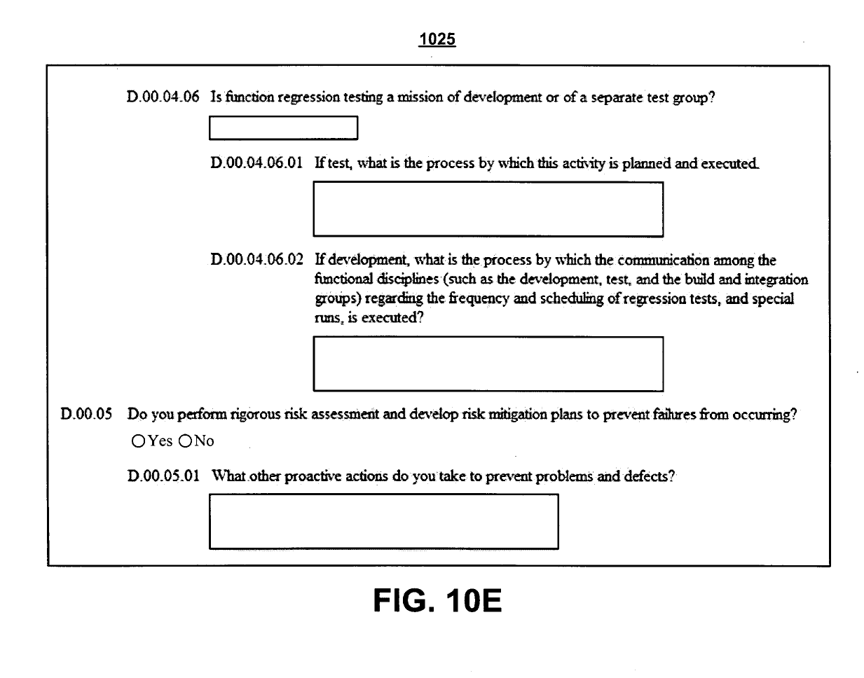

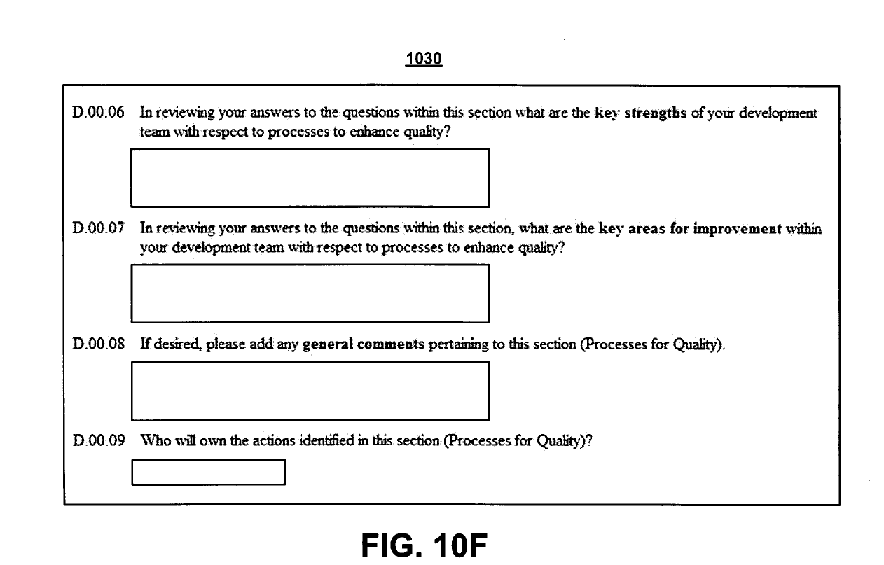

Section D, processes for quality, is shown in FIG. 10 (FIGS. 10A, 10B, 1C, 10D, 10E, and 10F). Screens 1005, 1010, 1015, 1020, 1025, and 1030 for those figures present exemplary questions that help the user characterize the current software development process used by the software development team, with an emphasis on design and code. The assessment in section D focuses on processes that, when preformed correctly, are instrumental in the creation of high quality software.

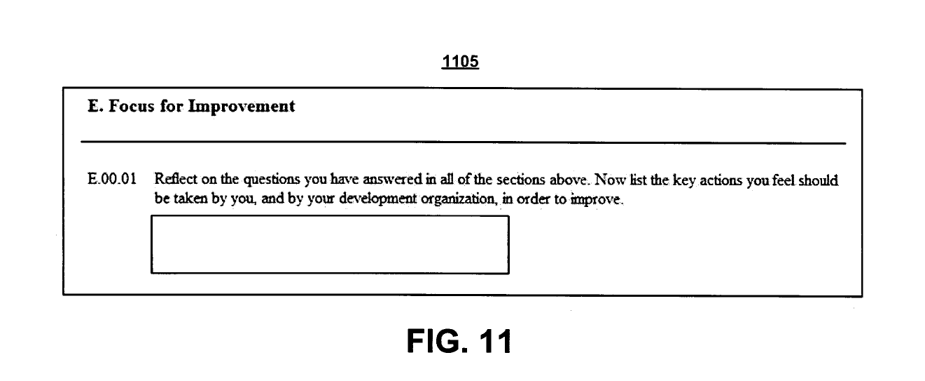

Section E, focus for improvement, is shown in FIG. 11. Screen 1105 provides the opportunity for the user to summarize the key actions that should be implemented by the software development team to improve performance.

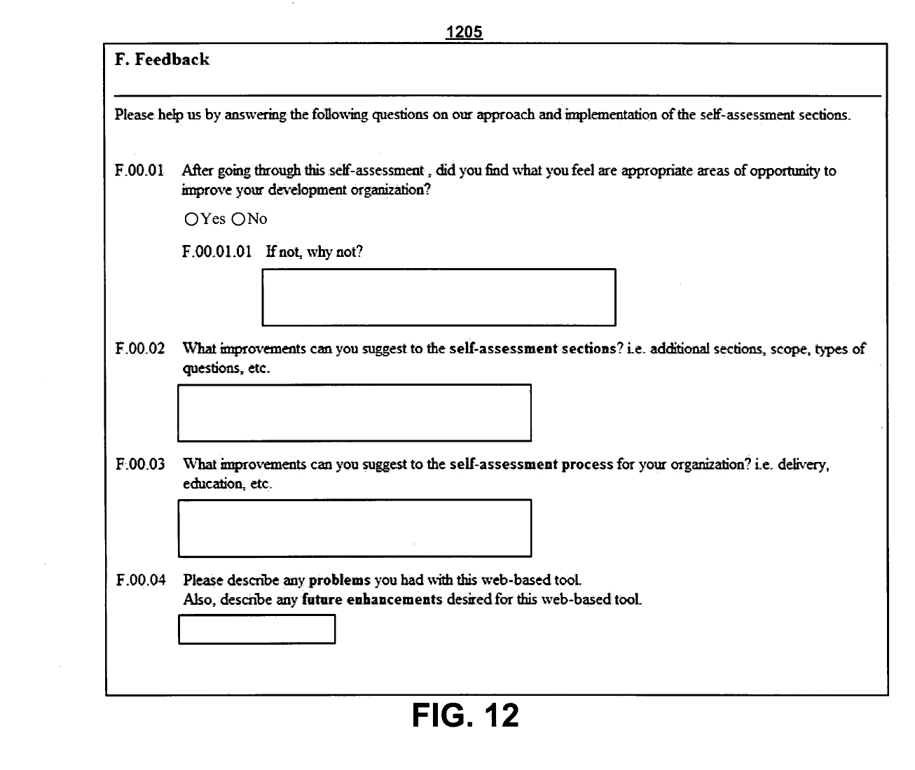

Section F, feedback, is shown in FIG. 12. Screen 1205 provides the opportunity for the user to critique the self-assessment process.

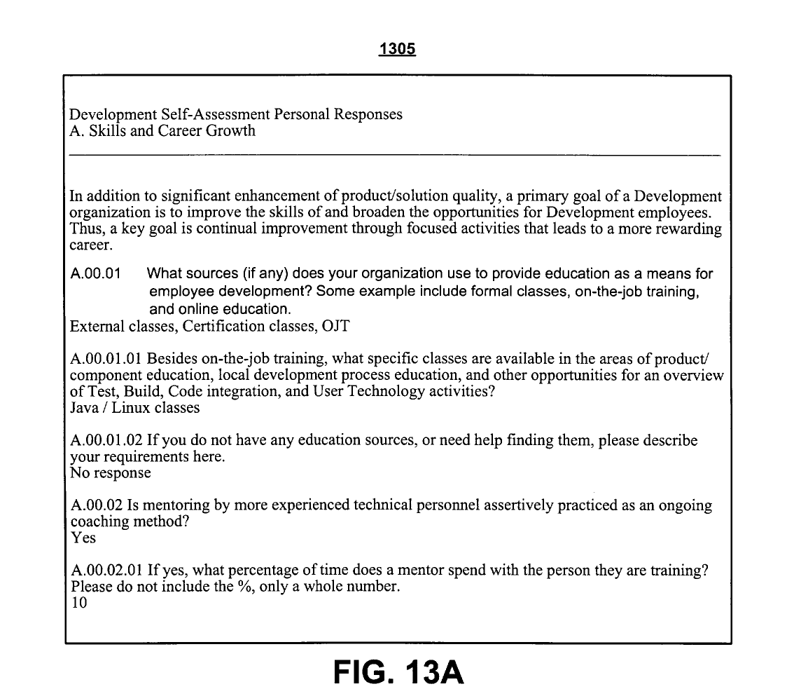

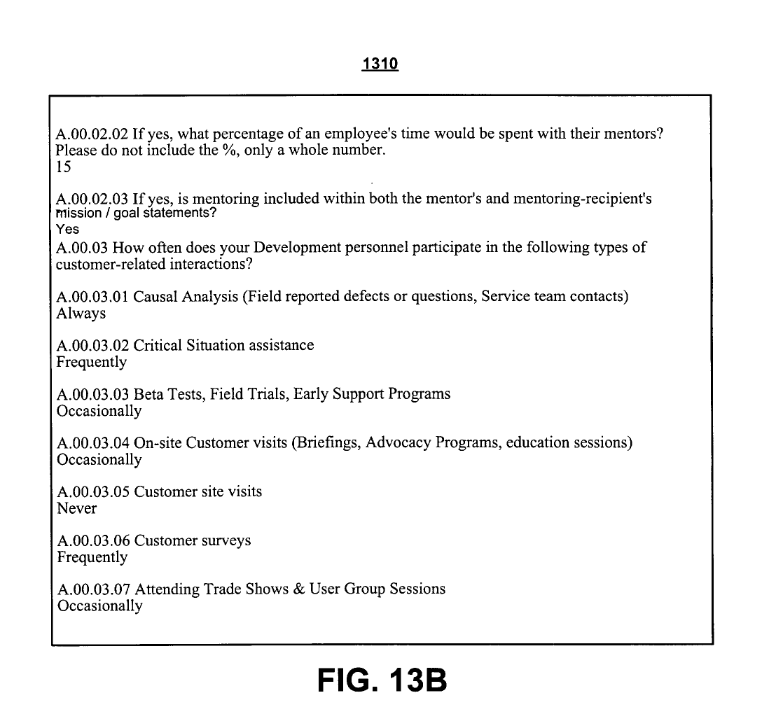

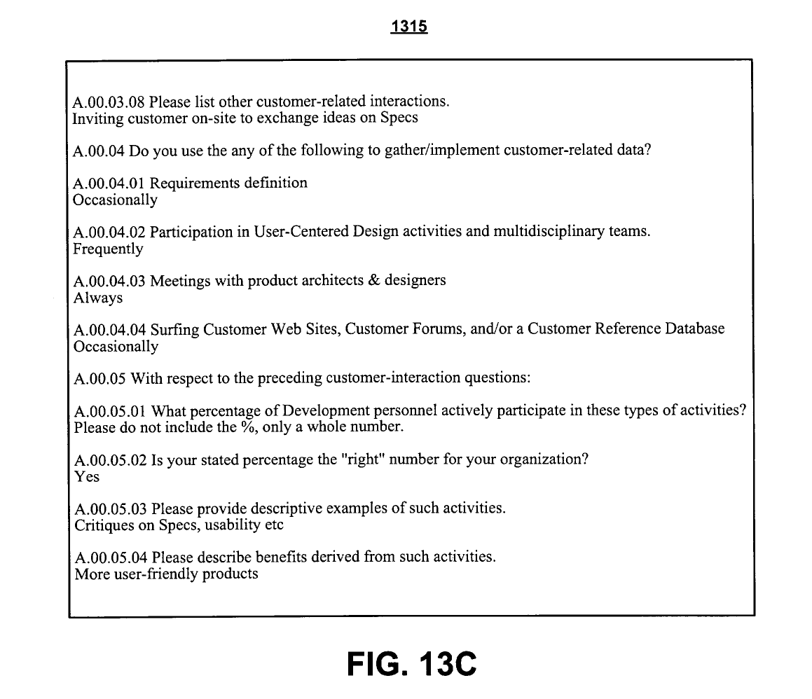

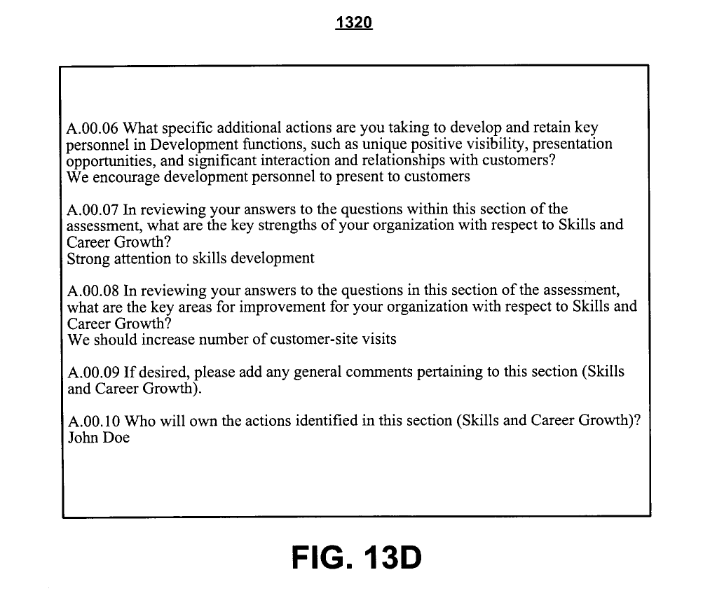

FIG. 13 (FIGS. 13A, 13B, 13C, and 13D) illustrates a series of exemplary response screens 1305, 1310, 1315, and 1320, to the assessment questions of section A (FIG. 3). For questions not answered, system 10 provides “no response”. The user can review these responses in FIG. 13 along with those of other members of the software development team and determine the effect any current software discipline has on the team and any needed improvements. An important feature of the present system is the ability to qualitatively compare the performance of a software development group with an expert standard.

It is to be understood that the specific embodiments of the invention that have been described are merely illustrative of certain application of the principle of the present invention. Numerous modifications may be made to the system for software development self-assessment invention described herein without departing from the spirit and scope of the present invention.

What is claimed is:

1. A method for developing a self-assessment evaluation of a user, comprising:
presenting the user with a first self-assessment good practice guide questionnaire;
accepting responses from the user in response to the first questionnaire;
storing the responses to the first questionnaire for subsequent analysis; and
analyzing the responses to the first questionnaire to determine an action plan for improvement.

2. The method of claim 1, further comprising presenting the user with at least a second self-assessment good practice guide questionnaire;
storing responses to the second questionnaire; and
comparing the responses to the second questionnaire with the responses to the first questionnaire.

3. The method of claim 1, further comprising selectively limiting access to the responses to the first questionnaire.

4. The method of claim 1, wherein the first questionnaire comprises questions about skills and career growth.

5. The method of claim 4, further comprising presenting the user with a self-assessment good practice guide questionnaire comprising questions about a development process.

6. The method of claim 4, further comprising presenting the user with a self-assessment good practice guide questionnaire comprising questions about results and measurements.

7. The method of claim 4, further comprising presenting the user with a self-assessment good practice guide questionnaire comprising questions about a process for quality.

8. The method of claim 4, further comprising presenting the user with a self-assessment good practice guide questionnaire comprising questions about a focus for improvement.

9. The method of claim 4, further comprising presenting the user with a self-assessment good practice guide questionnaire comprising questions about feedback.

10. The method of claim 4, further comprising presenting the user with a plurality of self-assessment good practice guide questionnaires comprising questions about a development process; results and measurements; a process for quality; a focus for improvement; and feedback.

11. A computer program product having instruction codes for developing a self-assessment evaluation of a user, comprising:
a first set of instruction codes for presenting the user with a first self-assessment good practice guide questionnaire;
a second set of instruction codes for accepting responses from the user in response to the first questionnaire;
a third set of instruction codes for storing the responses to the first questionnaire for subsequent analysis; and
a fourth set of instruction codes for analyzing the responses to the first questionnaire to determine an action plan for improvement.

12. The computer program product of claim 11, wherein the first set of instruction codes further presents the user with at least a second self-assessment good practice guide questionnaire;
the third set of instruction codes further store responses to the second questionnaire; and
a fifth set of instruction codes for comparing the responses to the second questionnaire with the responses to the first questionnaire.

13. The computer program product of claim 11, further comprising a sixth set of instruction codes for selectively limiting access to the responses to the first questionnaire.

14. The computer program product of claim 11, wherein the first questionnaire comprises questions about skills and career growth.

15. The computer program product of claim 14, wherein the first set of instruction codes further presents the user with a self-assessment good practice guide questionnaire comprising questions about a development process.

16. The computer program product of claim 14, wherein the first set of instruction codes further presents the user with a self-assessment good practice guide questionnaire comprising questions about results and measurements.

17. The computer program product of claim 14, wherein the first set of instruction codes further presents the user with a self-assessment good practice guide questionnaire comprising questions about a process for quality.

18. The computer program product of claim 14, wherein the first set of instruction codes further presents the user with a self-assessment good practice guide questionnaire comprising questions about a focus for improvement.

19. The computer program product of claim 14, wherein the first set of instruction codes further presents the user with a self-assessment good practice guide questionnaire comprising questions about feedback.

20. The computer program product of claim 14, wherein the first set of instruction codes further presents the user with a plurality of self-assessment good practice guide questionnaires comprising questions about a development process; results and measurements; a process for quality; a focus for improvement; and feedback.

21. A system for developing a self-assessment evaluation of a user, comprising:
means for presenting the user with a first self-assessment good practice guide questionnaire;
means for accepting responses from the user in response to the first questionnaire;
means for storing the responses to the first questionnaire for subsequent analysis; and
means for analyzing the responses to the first questionnaire to determine an action plan for improvement.

22. The system of claim 21, wherein the means for presenting further presents the user with at least a second self-assessment good practice guide questionnaire;
means for storing further store responses to the second questionnaire; and
means for comparing the responses to the second questionnaire with the responses to the first questionnaire.

23. The system of claim 21, further comprising means for selectively limiting access to the responses to the first questionnaire.

24. The system of claim 21, wherein the first questionnaire comprises questions about skills and career growth.

25. The system of claim 24, wherein the means for presenting further presents the user with a self-assessment good practice guide questionnaire comprising questions about a development process.

26. The system of claim 24, wherein the means for presenting further presents the user with a self-assessment good practice guide questionnaire comprising questions about results and measurements.

27. The system of claim 24, wherein the means for presenting further presents the user with a self-assessment good practice guide questionnaire comprising questions about a process for quality.

28. The system of claim 24, wherein the means for presenting further presents the user with a self-assessment good practice guide questionnaire comprising questions about a focus for improvement.

29. The system of claim 24, wherein the means for presenting further presents the user with a self-assessment good practice guide questionnaire comprising questions about feedback.

30. The system of claim 24, wherein the means for presenting further presents the user with a plurality of self-assessment good practice guide questionnaires comprising questions about a development process; results and measurements; a process for quality; a focus for improvement; and feedback.
